(19) United States
(12) Patent Application Publication
(10) Pub. No.: US 2011/0243412 A1
(43) Pub. Date: Oct. 6, 2011

(54) CORONARY ARTERY SELECTIVE CALCIUM ASSIGNMENT USING LOW DOSE CALCIUM SCORING SCANS

(75) Inventors: Michael Grass, Buchholz in der Norheide (DE); Jens Von Berg, Hamburg (DE)

(73) Assignee: KONINKLIJKE PHILIPS ELECTRONICS N.V., EINDHOVEN (NL)

(21) Appl. No.: 12/599,044

(22) PCT Filed: May 5, 2008
(86) PCT No.: PCT/IB08/51737

§ 371 Date: Nov. 6, 2009

(30) Foreign Application Priority Data
May 8, 2007 (EP) 07107664.0

(51) Int. Cl. G06K 9/00

(52) U.S. Cl. 382/131

(57) ABSTRACT

It is described a method for coronary artery selective calcium assignment by computed tomography, wherein the method comprising the steps of performing a low x-ray dose cardiac calcium scoring scan, obtaining a data set of said cardiac calcium scoring scan, generating reconstructed images from the data set of said cardiac calcium scoring scan, analyzing the reconstructed images for segmented calcium deposits, deriving a data set of calcification from the analysis, wherein a cardiac model is adapted to the reconstructed image such that segmented calcium deposits can be assigned to specific areas of the heart. Further a device (100) for performing a method for coronary artery selective calcium assignment by computed tomography according to the inventive method is described, wherein the device (100) comprises a CT unit (10) for performing a low x-ray dose cardiac calcium scoring scan; an acquisition unit (20) for obtaining a data set of said cardiac calcium scoring scan; a generation unit (30) for generating reconstructed images from the data set of said cardiac calcium scoring scan; an analyzing unit (40) for analyzing the reconstructed images for segmented calcium deposits; a deriving unit (50) for deriving a data set of calcification from the analysis.

### FIELD OF THE INVENTION

The present invention relates to the field of computed tomography, especially to the field of coronary artery selective calcium assignment by computed tomography (CT).

### BACKGROUND OF THE INVENTION

Calcium scoring is one of the major indications for cardiac computed tomography. Computed tomography scans are performed with prospective or retrospective gating without contrast agent application. Calcium scoring is interpreted as one of the risk factors for coronary artery disease. Moreover, for a large number of clinical users, high calcium scores resulting from these scans are an indication to not perform a subsequent coronary artery scan with contrast agent injection, but to directly send the patient for cardiac catheterisation. However, apart from the high calcium score derived from the CT scan, the CT information remains unused during the following catheter based intervention.

Thus, there may be a need to use data of a CT scan and to assign these data to selective coronary artery calcification.

### SUMMARY OF THE INVENTION

This need may be met by the subject matter according to the independent claims. Advantageous embodiments of the present invention are described by the dependent claims.

According to a first aspect of the invention a method for coronary artery selective calcium assignment by computed tomography is provided, wherein the method comprises the steps of performing a low x-ray dose cardiac calcium scoring scan, obtaining a data set of said cardiac calcium scoring scan, generating reconstructed images from the data set of said cardiac calcium scoring scan, analyzing the reconstructed images for segmented calcium deposits, deriving a data set of calcification from the analysis, and wherein a cardiac model is adapted to the data set of said calcium scoring scan such that segmented deposits can be assigned to specific areas of the heart.

Under the expression coronary artery selective calcium assignment by computed tomography is preferably understood that from computed tomography scans (CT scans) calcification of the coronary arteries of the heart can be assigned to anatomical entities by means of an adequate cardiac model.

Computed tomography, also known as CT scanning, uses an x-ray tube and a detector to obtain multiple x-ray images of any part of the body. The images are much more detailed than those provided by conventional x-ray observation methods. In addition, CT can display many different types of tissue including blood vessels. Modern scanners use a technique called spiral or helical CT to obtain images from many angles and z-positions (positions along the rotation axis). Computerized processing of these images creates cross-sections, or slices, of the area of interest. The images can then be examined on a computer monitor or printed out.

As CT devices can be used a multi-slice CT, cone beam CT, e-beam CT or a 3D-RA device, respectively C-arm CT system.

Cardiac CT for calcium scoring is a non-invasive way of obtaining information about the location and extent of calcified plaque in the coronary arteries—the vessels that supply oxygen—transporting blood to the heart wall. Plaque can be a build-up of fat and other substances, including calcium, which in time can narrow the arteries or even close off blood flow to the heart. The result may be painful angina in the chest or a heart attack. Calcium plaque deposition is an indication of coronary artery disease. The findings on cardiac CT, expressed as a calcium score, especially an Agatston score or a volume score, may help decide what measures can be taken to avoid these events. Another name for this test is coronary artery calcium scoring.

Under the step of performing a low x-ray dose cardiac calcium scoring scan is preferably understood that with CT a scan is performed. Preferably such a CT scan is performed without contrast agent, i.e. no contrast agent is injected into the heart of the patient. The x-ray dose during such a scan is preferably approximately between 1 and 10 mSv, most preferably the low x-ray dose is about 4.5 mSv. The exact dose values depend on the chosen protocol and the size of the patient.

Under the step of obtaining a data set of said calcium scoring scan is understood that information of the heart and calcified coronaries in form of data is achieved, wherein these data in further steps are analyzed and used for an adaptation of a cardiac (heart) model, see further below. The data set of said cardiac calcium scoring scan implicitly comprises data of the heart and of the coronaries.

Under the step of generating reconstructed images from the data set of said cardiac calcium scoring scan is preferably understood that the data, which are obtained of the CT scan, are processed via an adequate hardware and/or software, as it is known in the state of the art for CT.

Images of the CT scan can be reconstructed by said hardware and/or software. Therein, for a current high end scanner with multiple detector rows being operated in a retrospectively electrocardiogram gated helical acquisition mode, cone beam reconstruction methods for helical geometry can be best suited for the generation of the image volume (see Grass et. Al “Helical cardiac cone beam reconstruction using retrospective ECG gating”, Phys. Med. Biol. 48 (2003), 3069-3084). As image volume therein is understood the data set of the cardiac calcium scoring scan. Alternatively, a gated step and shoot or sequential acquisitions can employ fan-beam or cone-beam circular filtered back projection reconstruction methods in combination with prospective gating to generate the image data set.

Under the step of analyzing reconstructed images for segmented calcium deposits can be understood that areas of calcium deposits can be detected by thresholding. As segmented calcium deposits are understood calcium deposits which are specifically selected by the operator above a certain Hounsfield value. Typically, within the cardiac region of interest, covering the heart of the patient in the data set, all voxels representing a Hounsfield value above 130 HU are marked as calcified plaque. The selection of calcified volume areas can be done fully automatically using image processing methods or they can be supported by manual interaction.

As thresholding is understood that partial areas of images with a high enough Hounsfield value (HU-value) are marked in the CT scan of the heart. Data with a value, which lies below a certain Hounsfield value, are not marked. Preferably the Hounsfield value is above 130 Hounsfield.

Furthermore the step of analyzing reconstructed images for calcium deposits can use an Agatston score or a volume score.

Under an Agatston score can be understood a value, which is used to determine the coronary calcification. The Agatston score is based on the area and density of the calcified plaques in the arteries. An Agatston score of 0 indicates no calcification, between 0 and 10 it indicates minimal coronary calcification, between 10 and 100 it indicates little coronary calcification, between 100 and 400 it indicates a middle coronary calcification and above 400 a severe coronary calcification is indicated.

Under the expression volume score can be understood a value, which is also used to determine the calcification, wherein the volume of the calcification is determined. Thus, the overall volume occupied by calcified plaques in the coronary arteries can be estimated, i.e. the spatial distribution of the calcification in the arteries.

Thus, with the above mentioned thresholding, using Agatston and/or volume score the calcium deposits can be determined within the cardiac volume.

Under the step of deriving a data set of calcification from the analysis is preferably understood that by adequate methods, like the above mentioned thresholding, Agatston score or volume score, a data set can be obtained by the CT hardware and software. This data set contains information on the density and/or volume of the calcified plaque as well as the three-dimensional positions of the calcified plaque.

Under the step of adapting a cardiac model to the reconstructed CT images can be understood a deformation of this model to fit the corresponding anatomical entities in the image.

The cardiac model carries information about the basic cardiac anatomy, like left and right atrium, myocardium and ventricles of the heart and the coronary arteries and veins.

The cardiac model is adapted to the CT image thus allowing anatomical labelling of given positions in the image.

As a cardiac model adaptation can be used the method described in Hofmann et al., “Towards model-based localization of the three main coronary arteries in CT images” in Frangi, Delingette (Eds.) MICCAI workshop proceedings “From Statistical Atlases to Personalized Models: Understanding Complex Diseases in Populations and Individuals”, 2006, p. 53-56. In this method is described how coronary arteries additionally to the structures of the heart can be localized in the CT image even if they are only partially visible.

Further also the method as described in Ecabert et al. “Towards Automatic Full Heart Segmentation in Computed-Tomography Images”, 32nd IEEE Conference on Computers in Cardiology, Sep. 25-28, 2005, pp. 223-226 can be used for the adaptation to the cardiac calcium scoring scan. In this article it is described how an automatisation of adaptation of a heart model is achieved.

Finally also a cardiac model which is described in C. Lorenz, J. von Berg “A comprehensive model of the heart”, Medical Image Analysis 10, pp. 657-670, 2006 can be adapted to the cardiac calcium scoring scan. In this document is described how to estimate the position of coronary arteries when the heart chambers are already located.

With the above-mentioned methods the anatomical meaning of positions in the CT image can be given. Thus it is possible to assign from the detected calcifications, which have be determined by thresholding, the adequate anatomical structures. It is now possible to give information about calcification not only for the complete cardiac volume, but also for selected parts of the heart as LAD, RCA, LCX, aorta and heart valves.

After adapting the cardiac model to the low dose data set of the calcium scoring scan, the position of the surfaces or areas of the heart is known in the cardiac CT data set.

Also an averaged coronary model can be contained therein, wherein this average coronary model was adapted to the data set or at least the triangles on the heart surface which lie, statistically seen, near to a coronary of the heart. As an average coronary model can be understood a model which uses data for a coronary model which represent coronary positions obtained from a plurality of patients. This is frequently referred to as an implicit coronary model.

For each segmented calcification, of which the three-dimensional position is known in the same data set, the shortest distance to the model positions can be calculated. Therein each segmented calcification can be assigned, e.g. to a coronary. As a consequence the detected calcium is assigned to this coronary.

Due to knowledge on the relative position of all compartments, respectively areas of the heart (ventricles, atria, LAD, LCX, RCA, myocardium, valves), the calcium detected in the low dose scan is assigned by means of the cardiac model to the different compartments of the heart, due to e.g. the closest distance or any other appropriate measure.

Because of the derived data set of calcification it is possible with the cardiac model to determine the calcification of the coronary arteries. The visualisation thereby can be done by an adequate hardware and software as it is known in the state of the art for CT.

Thus information about calcification of the coronary arteries, like RCA, LCX, LAD, the ventricles, atria, myocardium and valves is obtained.

With the invention the advantage may be achieved that a fully automatic procedure can be obtained to assign the detected calcium deposits directly to the different vascular structures of the heart. Therein a fully automatic cardiac modeling is used to support intervention guidance or to perform spatially resolved calcium reporting.

The information about calcification in the heart can be used to guide interventional procedures of an interventional cardiologist (physician, respectively heart surgeon).

Furthermore indications during the intervention of a catheter for strong calcifications can be obtained. Thus, it is possible to use this information during a catheterisation, as for the operator a path of the catheter can be given, which reduces the risk of complications during such a catheterisation.

Also a fully automatic reporting on calcifications by assigning the calcifications to different compartments of the heart and/or to the vascular structures is possible.

According to a further embodiment of the invention the step of the low dose cardiac calcium scoring comprises the steps of a prospective and/or retrospective gating.

Under prospective gating is preferably understood that during a CT scan only a certain interval of the heart cycle is scanned.

Under retrospective gating is preferably understood that during a CT scan a complete interval of the heart cycle is scanned.

Gating can be based essentially on the measuring of an electrocardiogram (ECG), wherein the measuring can be done in parallel to an acquisition of data of projection.

The periodicity of the heart cycle can be determined by means of a R wave in the ECG.

A point of time in ECG can be executed via a percental indication of the length of a heart beat (e.g. by reconstruction at 70% in the RR interval).

At retrospective gating projections can be determined by means of the ECG after the scan. The projections can lie in a time region of 20% RR (+/−10%) for a ECG of approximately 70%. From these projections the image can be determined.

At prospective gating a fixed point of time after the last R wave can be assumed. For example the X-ray tube can be switched on 200 msec after the last R wave and can be operated for a half rotation plus a fan angle. Thus, from prospective gating a layer (part-volume) can be reconstructed.

Retrospective gating is preferred, since the cardiac phase of reconstructing the calcium scoring data set can be chosen freely, and thereby, the resting phase of highest image quality can be chosen for the image generation. Prospective gating is preferable with respect to applied X-ray dose, since the data are not measured redundantly. However, only an image in a single cardiac phase can be generated and the phase must be chosen prior to the scan.

Prospective or retrospective gating can further be executed in a helical mode, step and shoot mode, respectively sequential mode.

According to a further embodiment of the present invention the step of generating reconstructed images from the cardiac calcium scoring scan uses preferably a thresholding method.

As already described above, under the expression thresholding, respectively thresholding method, is understood that only partial areas of images with a high enough Hounsfield value (HU-value) are selected from the CT scan of the heart. Data with a value, which lies below a certain Hounsfield value, are not selected . Preferably the Hounsfield value is about 130 Hounsfield.

According to a further embodiment of the present invention the step of analyzing reconstructed images for calcium deposits uses preferably an Agatston score and/or a volume score.

As already describe above under an Agatston score can be understood a value, which is used to determine the coronary calcification. The Agatston score is based on the area and density of the calcified plaques in the arteries.

A volume score can be understood as a value, which is also used to determine the calcification, wherein the volume of the calcification is determined. Thus a density distribution of the calcification in the coronary arteries can be estimated, i.e. the spatial distribution of the calcification in the arteries.

Thus, with the above mentioned thresholding, using Agatston and/or volume score preferably the calcium deposits can be determined within the cardiac volume.

According to a further aspect of the invention a device for performing the method for coronary artery selective calcium assignment by computed tomography as described above is provided, wherein the device comprises a CT unit for performing a low x-ray dose cardiac calcium scoring scan, an acquisition unit for obtaining a data set of said cardiac calcium scoring scan, a generation unit for generating reconstructed images from the data set of said cardiac calcium scoring scan, an analyzing unit for analyzing the reconstructed images for segmented calcium deposits and a deriving unit for deriving a data set of calcification from the analysis.

According to a further aspect of the invention there is provided a computer program product storable on a medium readable by a computing, imaging and/or printer system, comprising a software code section which induces the computing, imaging and/or printer system to execute the method as described herein above when the product is executed on the computing, imaging and/or printer system.

According to a further aspect of the invention there is provided a computer readable product, on which a computer program product according to the above aspect is stored.

It has to be noted that embodiments of the invention have been described with reference to different subject matters. In particular, some embodiments have been described with reference to apparatus type claims whereas other embodiments have been described with reference to method type claims. It has to be pointed out that of course any combination of features relating to different subject matters is also possible.

The aspects defined above and further aspects of the present invention are apparent from the examples of embodiment to be described hereinafter and are explained with reference to the examples of embodiment. The invention will be described in more detail hereinafter with reference to examples of embodiment but to which the invention is not limited.

On the basis of the above given and the following explanation of the method for coronary artery selective calcium assignment by CT a skilled person will be able to translate the steps of the method into a computer program for carrying out the method.

In the following there will be described an exemplary embodiment of the present invention with reference to a method for a coronary artery selective calcium assignment.

### BRIEF DESCRIPTION OF THE DRAWINGS

FIG. 1 shows CT-images of a human heart with calcifications.

FIG. 2 shows a cardiac model with areas of calcification of the human heart derived with an embodiment of the inventive method.

FIG. 3 shows a schematic side view of a device for performing the inventive method according to an embodiment of the invention.

### DETAILED DESCRIPTION OF THE EMBODIMENTS

The illustration in the drawings is schematically.

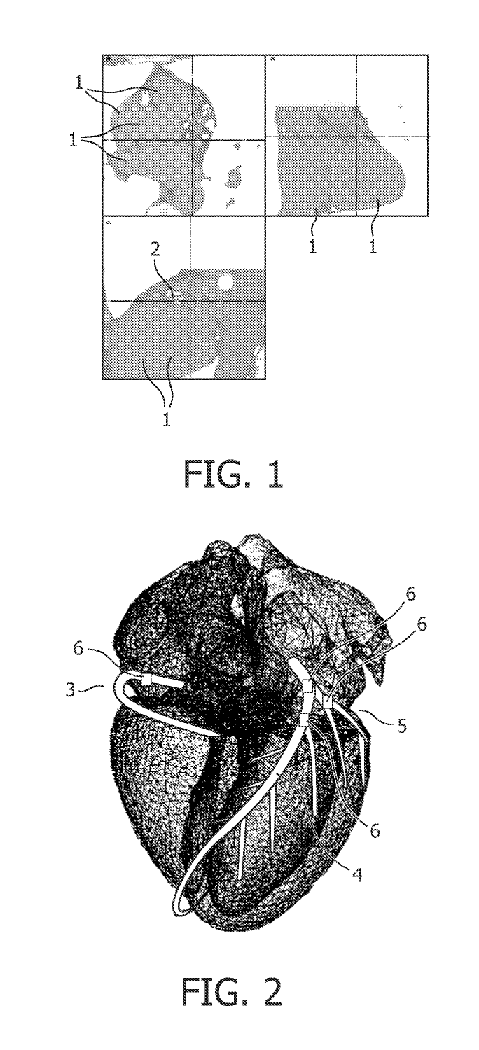

FIG. 1 shows three different CT images of the human heart acquired with a low x-ray dose. The CT images where achieved from different cross-sections of human heart.

In the three pictures different areas 1 of the heart are illustrated. Further in 2 a calcification of a coronary artery can be seen as gray point.

The black point in the third image of FIG. 1 shows a cross-section through the left bronchus of the human body.

In the three images of FIG. 1 the threshold of the CT scan is approximately 140 Hounsfield, such that calcifications in different areas 1 of the heart can be seen in circular, elliptical or other form, which is surrounded by a white line. The different areas 1 show the left atrium, the right atrium, the left ventricle, the left ventricle, the aorta and the pulmonary artery of the human heart.

Because of the adaptation of the heart model to the CT data set these areas 1 are automatically identified in the CT image.

The reference sign 2 shows a calcification in an coronary artery, especially the LCX.

The images therein are build up from data, which are recorded by an adequate CT-hardware and software as known for CT devices.

As described above in the summary of the invention different method steps are executed to obtain these CT images, like performing a low x-ray dose cardiac calcium scoring scan, obtaining a data set of said calcium scoring scan, generating reconstructed images from the cardiac calcium scoring scan, analyzing reconstructed images for calcium deposits and deriving a data set of calcification from the analysis.

Later on a cardiac model is adapted to the data set of the calcium scoring scan such that segmented calcium deposits can be assigned to specific areas of the heart.

FIG. 2 shows a computed model of the coronary artery tree and of the heart, which was computed according to the cardiac model described in the article of Hofmann et al. “Towards model-based localization of the three main coronary arteries in CT images”.

At reference sign 3 the RCA (right arteria coronaria dextra) of the human heart can be seen. At reference sign 4 the LAD (left anterior descending) of the human heart and at reference sign 5 the LCX (left circumflex coronary artery) can be seen. When using a data set of calcification, which is imaging the human heart in different cross-sections in FIG. 1, and adapting these data set of the calcium scoring scan to a cardiac model, like the described models in the articles of Hofmann et al. and Ecabert et. al, areas of calcification in the coronary arteries in the heart can be represented as it is shown as white rectangle at reference sign 6 of FIG. 2.

Thus, information, which is obtained in x-ray low dose CT scans, can be used to obtain information about coronary arteries calcification in the heart by adapting a cardiac model to the data set, which was achieved from the CT scans.

As a consequence the information of calcification can be used by a doctor, especially a surgeon during catheterisation of a patient. Thus, the risk of damages of the coronary arteries can be reduced.

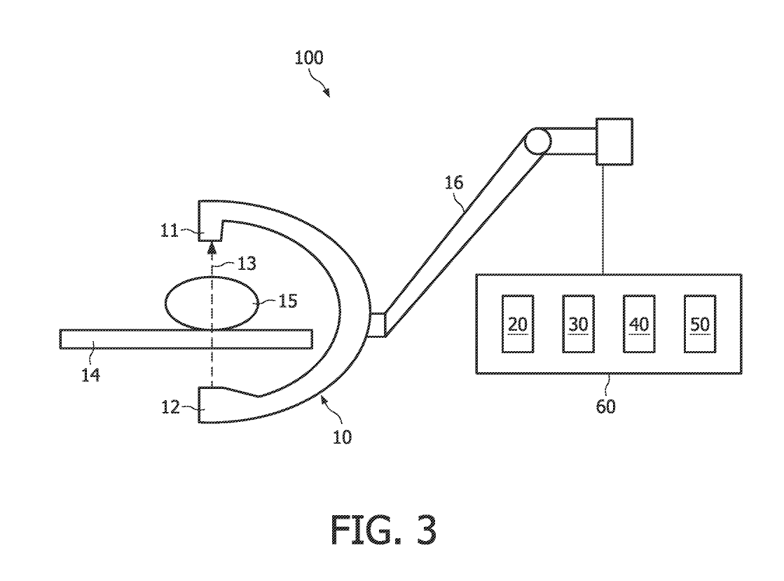

Finally, referring to FIG. 3 of the drawing, a device 100 for performing a method for coronary artery selective calcium assignment by computed tomography is figured.

Said device 100 comprises according to an embodiment of the invention a CT unit 10, especially a swing arm scanning system (C-arm) supported proximal a patient table 14 by a robotic arm 16. Housed within the swing arm of the CT unit 10, there is provided an X-ray tube 12 and an X-ray detector 11. The X-ray detector 11 is arranged and configured to receive X-rays 13, which have passed through a patient 15 representing the object under examination. Further, the X-ray detector 11 is adapted to generate an electrical signal representative of the intensity distribution thereof. By moving the swing arm of the CT unit 10, the X-ray tube 12 and the detector 11 can be placed at any desired location and orientation relative to the patient 15.

The device 100 further comprises an acquisition unit 20, a generation unit 30, an analyzing unit 40 and a deriving unit 50, which are accommodated within a workstation or a personal computer 60. The acquisition unit 20 is adapted for obtaining a data set of a cardiac calcium scoring scan. The generation unit 30 is adapted for generating reconstructed images from the data set of said cardiac calcium scoring scan. Further, the analyzing unit 40 is adapted for analyzing the reconstructed images for segmented calcium deposits and the deriving unit 50 is adapted for deriving a data set of calcification from the analysis.

It should be noted that the term “comprising” does not exclude other elements or steps and the “a” or “an” does not exclude a plurality. Also elements described in association with different embodiments may be combined. It should also be noted that reference signs in the claims should not be construed as limiting the scope of the claims.

In order to recapitulate the above described embodiments of the present invention one can state that with the present invention anatomical information of the calcification of coronary arteries, which is achieved with the above-described inventive method can be used for guide interventional procedures during catheterisation.

### LIST OF REFERENCE SIGNS

area of human heart

calcificated coronary artery of human heart

RCA of the heart

LAD of the heart

LCX of the heart

Calcified area of LAD

CT unit

X-ray detector

X-ray tube

X-rays

patient table

patient

robotic arm

acquisition unit

generation unit

analyzing unit

deriving unit

60 workstation

100 device for performing the inventive method

1. A method for coronary artery selective calcium assignment by computed tomography, wherein the method comprising the steps of:
performing a low x-ray dose cardiac calcium scoring scan;
obtaining a data set of said cardiac calcium scoring scan;
generating reconstructed images from the data set of said cardiac calcium scoring scan;
analyzing the reconstructed images for segmented calcium deposits;
deriving a data set of calcification from the analysis;
wherein a cardiac model is adapted to the reconstructed images of said calcium scoring scan such that segmented calcium deposits can be assigned to specific areas of the heart.

2. The method according to claim 1, wherein the step of said low dose cardiac calcium scoring comprises the steps of a prospective or retrospective gating.

3. The method according to claim 1, wherein a thresholding method is applied to the generated reconstructed images from the cardiac calcium scoring scan.

4. The method according to claim 1, wherein the step of analyzing reconstructed images for calcium deposits uses an Agatston score and/or a volume score.

5. A device for performing a method for coronary artery selective calcium assignment by computed tomography according to claim 1, comprising:
a CT unit for performing a low x-ray dose cardiac calcium scoring scan;
an acquisition unit for obtaining a data set of said cardiac calcium scoring scan;
a generation unit for generating reconstructed images from the data set of said cardiac calcium scoring scan;
an analyzing unit for analyzing the reconstructed images for segmented calcium deposits;
a deriving unit for deriving a data set of calcification from the analysis.

6. A computer program product storable on a medium readable by a computing, imaging and/or printer system, comprising a software code section which induces the computing, imaging and/or printer system to execute the method as claimed in claim 1 when the product is executed on the computing, imaging and/or printer system.

7. A computer readable product, on which a computer program product according to claim 6 is stored.
